(19) United States
(12) Patent Application Publication
(10) Pub. No.: US 2011/0161047 A1
(43) Pub. Date: Jun. 30, 2011

(54) INFORMATION PROCESSING DEVICE, INFORMATION PROCESSING METHOD, AND PROGRAM

(76) Inventor: Naoya SAZUKA, Tokyo (JP)

(21) Appl. No.: 12/971,842

(22) Filed: Dec. 17, 2010

(30) Foreign Application Priority Data
Dec. 25, 2009 (JP) P2009-296061

(51) Int. Cl. G06F 17/18

(52) U.S. Cl. 702/179

(57) ABSTRACT

Provided is an information processing device including a parameter setting unit that sets a parameter to be used for calculating a given statistic based on event occurrence time information related to a time when a certain event occurred, a period dividing unit that divides a calculation period for which the given statistic is calculated into a plurality of unit periods based on a base unit time set by the parameter setting unit, a count unit that counts a number of occurrences of the certain event for each of the plurality of unit periods based on the event occurrence time information, and a statistic calculation unit that calculates a statistic indicating a pattern of occurrences of the certain event by using a count result of the count unit.

### BACKGROUND OF THE INVENTION

1. Field of the Invention

The present invention relates to an information processing device, an information processing method, and a program.

2. Description of the Related Art

In the fields of medicine, pharmacy, science and engineering and so on, analysis that estimates the time from a certain point of time to the occurrence of an incident of interest is performed frequency (cf. e.g. Jinfang Wang, “Introduction to Survival Time Analysis”, [online], May 13, 2005, Chiba University [searched on Dec. 10, 2009], Internet <URL: http://www.math.s.chiba-u.ac.jp/˜wang/suvival.pdf>). The analysis is often used for estimating a rate that a person in a certain population dies (death rate) particularly in the medical and pharmaceutical fields, and it is called survival time analysis. Specifically, in this example, the incident of interest is “person's death”, and the time to the occurrence of the incident is the survival time of that person.

### SUMMARY OF THE INVENTION

Cases can occur where the survival time analysis is applied to the situation in which an event that is used for determination as to the occurrence of an incident can occur a plurality of times during a certain period. On the other hand, the survival time analysis is a method that performs prescribed analysis by focusing attention on a group of data sets (e.g. a group of persons) and using the time when a certain event occurred last time on the elements constituting the group of interest. Therefore, in the case of applying the survival time analysis according to related art to the incident where an event occurs a plurality of times during a certain period, various kinds of statistics such as survival time are calculated with no consideration of the pattern of occurrences of the event during the period. This raises a problem that, even when two kinds of elements with significantly different patterns of event occurrences exist, similar statistics are calculated for those elements.

In light of the foregoing, it is desirable to provide a novel and improved information processing device, information processing method and program which can calculate statistics in consideration of the pattern of event occurrences.

According to an embodiment of the present invention, there is provided an information processing device including a parameter setting unit that sets a parameter to be used for calculating a given statistic based on event occurrence time information related to a time when a certain event occurred, a period dividing unit that divides a calculation period for which the given statistic is calculated into a plurality of unit periods based on a base unit time set by the parameter setting unit, a count unit that counts a number of occurrences of the certain event for each of the plurality of unit periods based on the event occurrence time information, and a statistic calculation unit that calculates a statistic indicating a pattern of occurrences of the certain event by using a count result of the count unit.

The count unit preferably specifies a most recent unit period during which the certain event occurred from the calculation period, and the statistic calculation unit preferably calculates a density of occurrences of the certain event by using a number of occurrences of the certain event up to the most recent unit period, and calculates an average number of occurrences of the certain event within the calculation period by using the density of occurrences of the certain event and a number of the unit periods included up to the most recent unit period.

The information processing device preferably further includes a selection unit that selects the event occurrence time information with the same calculation period from a plurality of event occurrence time information. The count unit preferably counts the number of occurrences of the certain event based on the event occurrence time information selected by the selection unit.

The statistic calculation unit preferably calculates an average number A of occurrences of the certain event based on an expression 1, where a number of the event occurrence time information selected by the selection unit is N, the density of occurrences of the event is Wᵢ, and the number of the unit periods included up to the most recent unit period is tᵢ.

$$A = \frac{1}{N} {\sum }_{i = 1}^{N} {t}_{i} \times {W}_{i} \qquad ( Expression 1 )$$

When the certain event occurs during the unit period, the count unit may count the number of occurrences of the certain event in the unit period as 1 regardless of the number of occurrences.

The statistic calculation unit may further calculate a survival function indicating a rate of occurrence of the event, a hazard function of the event, and an event occurrence half-life indicating a period until the number of occurrences of the event becomes half based on the count result of the count unit.

According to another embodiment of the present invention, there is provided an information processing method including the steps of setting a parameter to be used for calculating a given statistic based on event occurrence time information related to a time when a certain event occurred, dividing a calculation period for which the given statistic is calculated into a plurality of unit periods based on a base unit time set in the parameter setting step, counting a number of occurrences of the certain event for each of the plurality of unit periods based on the event occurrence time information, and calculating a statistic indicating a pattern of occurrences of the certain event by using a count result in the counting step.

According to another embodiment of the present invention, there is provided a program causing a computer to implement functions including a parameter setting function that sets a parameter to be used for calculating a given statistic based on event occurrence time information related to a time when a certain event occurred, a period dividing function that divides a calculation period for which the given statistic is calculated into a plurality of unit periods based on a base unit time set by the parameter setting function, a count function that counts a number of occurrences of the certain event for each of the plurality of unit periods based on the event occurrence time information, and a statistic calculation function that calculates a statistic indicating a pattern of occurrences of the certain event by using a count result of the count function.

According to the embodiments of the present invention described above, it is possible to calculate statistics in consideration of the pattern of event occurrences.

### BRIEF DESCRIPTION OF THE DRAWINGS

FIG. 1 is an explanatory view to explain survival time analysis.

FIG. 2 is an explanatory view to explain survival time analysis.

FIG. 3 is an explanatory view to explain survival time analysis.

FIG. 4 is a graph to explain an example of a survival function.

FIG. 5 is a graph to explain an example of a hazard function.

FIG. 6 is an explanatory view to explain survival time analysis.

FIG. 7 is a block diagram to explain a configuration of an information processing device according to a first embodiment of the present invention.

FIG. 8 is an explanatory view to explain an example of event occurrence information.

FIG. 9 is an explanatory view to explain an information processing method according to the embodiment.

FIG. 10 is an explanatory view to explain an information processing method according to the embodiment.

FIG. 11 is an explanatory view to explain an information processing method according to the embodiment.

FIG. 12A is an explanatory view to explain an information processing method according to the embodiment.

FIG. 12B is an explanatory view to explain an information processing method according to the embodiment.

FIG. 13 is an explanatory view to explain an information processing method according to the embodiment.

FIG. 14 is an explanatory view to explain an information processing method according to the embodiment.

FIG. 15 is an explanatory view to explain an information processing method according to the embodiment.

FIG. 16 is a block diagram to explain a hardware configuration of an information processing device according to an embodiment of the present invention.

### DETAILED DESCRIPTION OF THE EMBODIMENT(S)

Hereinafter, preferred embodiments of the present invention will be described in detail with reference to the appended drawings. Note that, in this specification and the appended drawings, structural elements that have substantially the same function and structure are denoted with the same reference numerals, and repeated explanation of these structural elements is omitted.

The explanation will be given in the following order.

(1) Basic Technology

(2) Objectives

(3) First Embodiment

(3-1) Configuration of Information Processing Device

(3-2) Information Processing Method

(4) Hardware Configuration of Information Processing Device According to Embodiment of Present Invention

(5) Summary

Before providing description of an information processing device and an information processing method according to an embodiment of the present invention, technological matters that form the basis for implementing the embodiment of the present invention are described hereinafter. Note that the embodiment of the present invention is configured so as to obtain more significant advantageous effects by adding improvements to the basic technology described below. Therefore, the technique related to the improvements is a feature of the embodiment. Thus, it should be noted that, although the embodiment of the present invention follows the fundamental concept of the technological matters described hereinafter, the essence of the embodiment is rather integrated into the improved parts, and the configuration is clearly different, and there is also a clear distinction in advantageous effects from the basic technology.

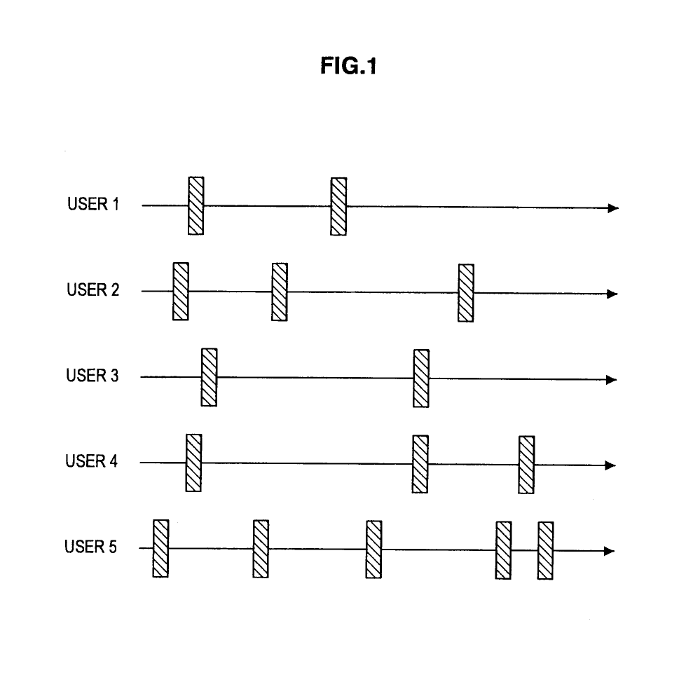

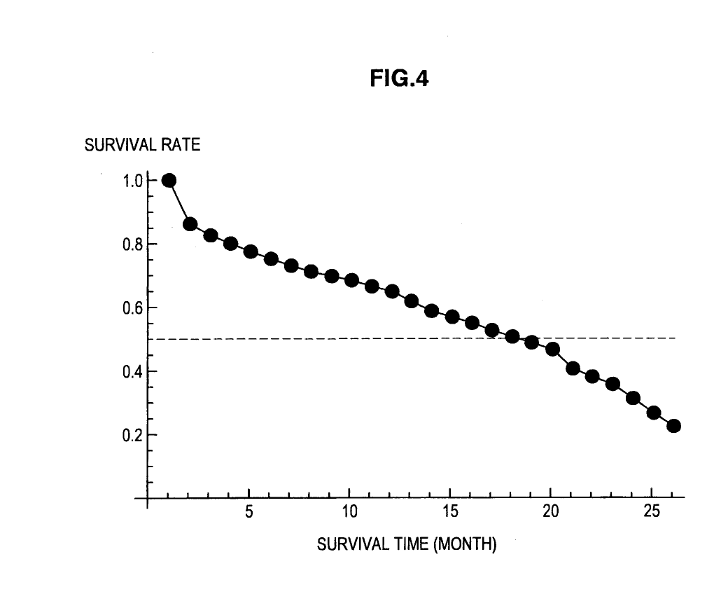

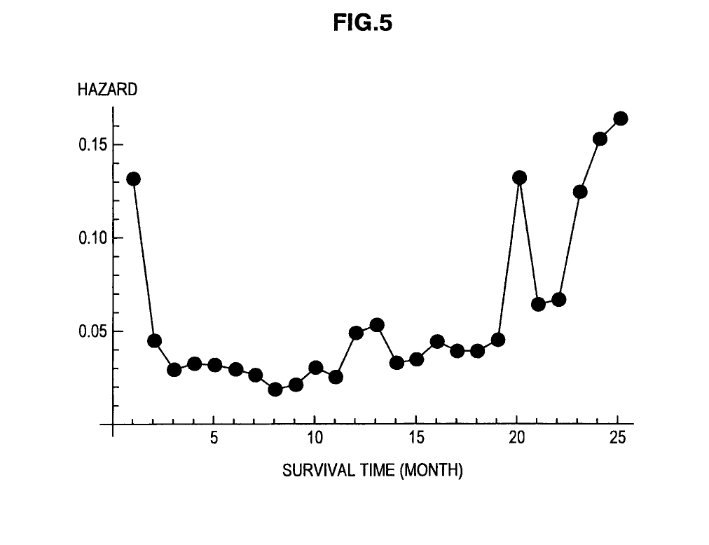

Hereinafter, a flow of survival time analysis, which is the technology that form the basis of the present invention, is described briefly with reference to FIGS. 1 to 5. FIGS. 1 to 3 are explanatory views to explain survival time analysis, FIG. 4 is a graph to explain an example of a survival function, and FIG. 5 is a graph to explain an example of a hazard function.

The survival time analysis is a technique that estimates the time from a certain point of time to the occurrence of an incident of interest. There are various examples of the incident of interest, such as the time to develop a disease, the time to produce side effects of a drug, the time for a person to pass away, and the time to breakdown of a machine.

In the survival time analysis, a function called the survival function is often of interest. The survival function is defined as the probability that the time (survival time) T to the occurrence of an incident is later than t, where t is a variable indicating time. The survival function can be formulated into the following expression 11.

In the following expression 11, S(t) is the survival function, and f(t) is the probability density function of the survival time T.

Further, in the survival time analysis, a function called the hazard function is sometimes of interest, in addition to the survival function. The hazard function is defined as the probability that an event occurs at time t on condition that the time T to the occurrence of an incident of interest satisfies T>t. The hazard function can be formulated into the following expression 12. In the following expression 12, H(t) is the hazard function.

When the cumulative distribution function of the survival time T is F(t), the definition is represented by the following expression 13. As is obvious from the expressions 11 and 13, because Pr(T>t)=1-Pr(T≦t), the cumulative distribution function of the survival time T and the survival function have the relationship of the following expression 14.

Differentiating the both sides of the expression 14 with respect to time t gives the relationship represented by the following expression 15. Therefore, the stochastic differential equation represented by the following expression 16 can be obtained from the expressions 12 and 15. Further, because the survival rate at t=0 is 1, if the differential equation represented by the expression 16 is solved under the initial condition of S(0)=1, the relational expression represented by the following expression 17 can be obtained. The relational expression of the expression 17 is an expression indicating the relationship between the survival function S(t) and the hazard function H(t). Therefore, if one of the survival function S(t) and the hazard function H(t) is known, the other function can be calculated by using the relational expression of the expression 17.

$$\begin{matrix}S ( t ) = Pr ( T > t ) = {\int }_{x}^{∞} f ( t ) d t & ( Expression 11 ) \\ H ( t ) = \frac{f ( t )}{{\int }_{x}^{∞} f ( t ) d t} & ( Expression 12 ) \\ F ( t ) = Pr ( T \leq t ) & ( Expression 13 ) \\ S ( t ) = 1 - F ( t ) & ( Expression 14 ) \\ {S}^{′} ( t ) = {( 1 - F ( t ) )}^{′} = - {F}^{′} ( t ) = - f ( t ) & ( Expression 15 ) \\ H ( t ) = - \frac{1}{S ( t )} \cdot \frac{d S ( t )}{d t} & ( Expression 16 ) \\ S ( t ) = exp ( - {\int }_{0}^{t} H ( t ) d t ) & ( Expression 17 )\end{matrix}$$

However, in the actual phenomenon, the probability density function of the survival time T is not represented by complete expressions such as exponential distribution, Weibull distribution and log-normal distribution in often cases. In such cases, the survival function S(t) can be estimated by using a nonparametric technique as follows. As an example of the nonparametric technique, there is a method of using Kaplan-Meier estimate. Hereinafter, an estimation method of the survival function S(t) using the Kaplan-Meier estimate is briefly described.

In the method of estimating the survival function, information related to the time when a certain event occurs (which is referred to hereinafter as the event occurrence time information) is prepared. In the following description, history information that indicates the time when a certain user logs in to a certain service is taken as an example of the event occurrence time information, and the time to the occurrence of an incident that “the user withdraws from the service” is the survival time T.

Next, in the method of estimating the survival function, the period T (e.g. one year etc.) for which the survival function is calculated and the unit time t (e.g. one month, one week etc.) are determined, and selection of users who have started the service in the same unit time is made.

FIG. 1 illustrates the points of time when the event occurs on the time axis by referring to the event occurrence time information for each of the users selected in the above manner. In FIG. 1, five users from the user 1 to the user 5 (the number of users N=5) are of interest, and the diagonally shaded rectangle indicates the time when the event occurred (i.e. the time when the user logged in).

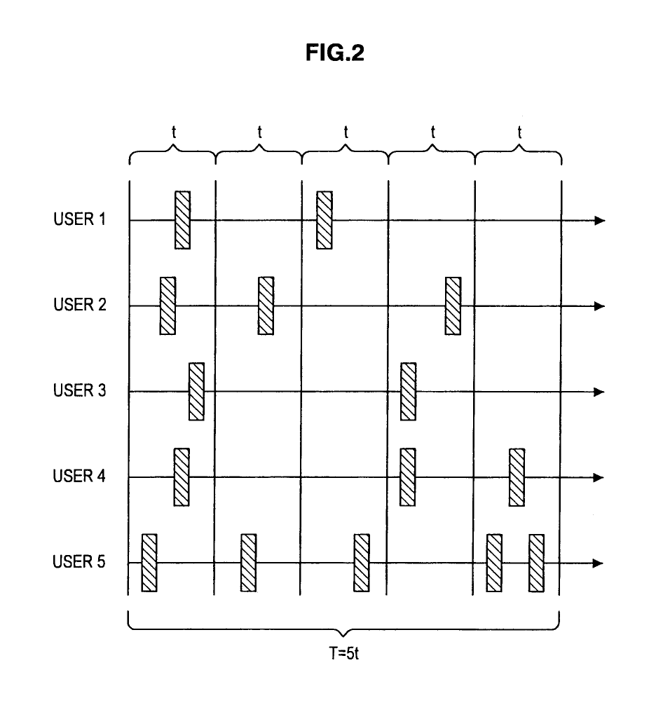

When the period T for which the survival function is calculated is set to five months and the unit time t is set to one month, in the method of estimating the survival function, it is determined whether the incident that “the user withdraws from the service” has occurred or not on the basis of the interval of each unit time t as shown in FIG. 2, for example. The incident that “the user withdrew from the service” can be determined from the viewpoint that “the user logged in last time”. As is obvious from FIG. 2, the last access time of the user 1 belongs to the third interval from the left, the last access time of the user 2 and the user 3 belongs to the fourth interval from the left, and the last access time of the user 4 and the user 5 belongs to the rightmost interval.

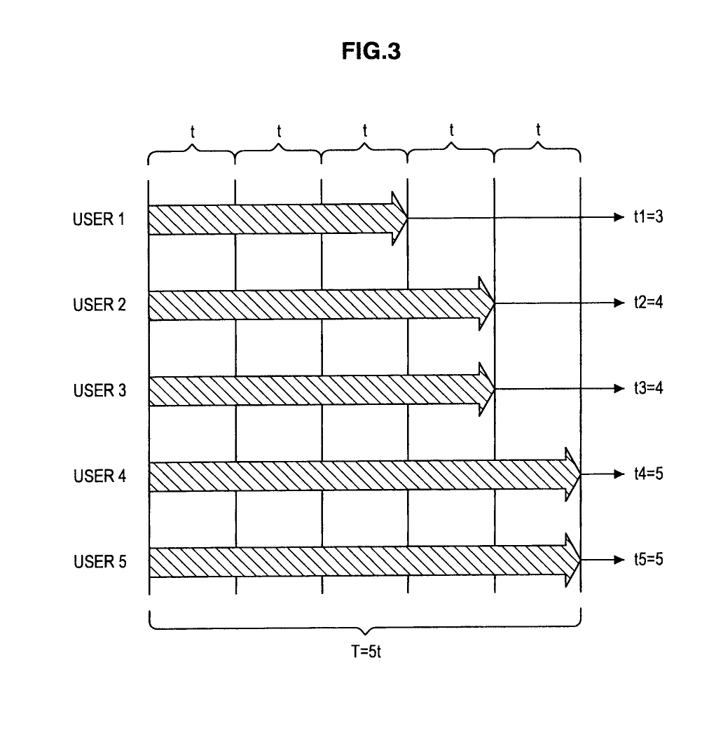

In the estimation of the survival function, only two points of time, i.e. a reference time point and a time point when an incident of interest occurred, are of interest. Therefore, in the example shown in FIGS. 1 to 2 also, when estimating the survival function, the login of each user is considered that user's access has continued until “an interval ti in which a user i made access last time” as shown in FIG. 3.

The survival function S(t) (Kaplan-Meier estimate) at time t is a value represented by (the number of persons satisfying tit/the total number of persons). Therefore, in the example shown in FIGS. 1 to 3, S(1)=5/5=1, S(2)=5/5=1, S(3)=5/5=1, S(4)=4/5, and S(5)=2/5.

FIG. 4 illustrates the survival function S(t) which is calculated by using the above method for N number of users who have started a certain service in the same month, where the base unit time t is one month and the period T of interest is 26 months. In FIG. 4, the horizontal axis indicates the survival time, and the vertical axis indicates the survival rate.

Further, if the survival function S(t) can be estimated, the statistics of half-life and average survival time can be calculated. The half-life is defined as the time when the survival rate becomes 50%. Thus, in the survival function as shown in FIG. 4, for example, the half-life can be obtained by calculating the x-coordinate with the survival rate=0.5. In the example of FIG. 4, the half-life is about 19 months.

Further, the average survival time is the time when the user survives on average during the period of interest, and it is represented as the area of a region surrounded by the survival function S(t), x=0 and x=T in the graph of the survival function as shown in FIG. 4, for example. When the average survival time is a, the average survival time a is represented by the following expression 18.

$$a = \frac{1}{N} {\sum }_{i = 1}^{N} {t}_{i} \qquad ( Expression 18 )$$

For example, the average survival time a in the example shown in FIGS. 1 to 3 is (3+4+4+5+5)/5=4.2.

Further, the hazard function can be calculated also. In this case, the hazard function H(t) is represented as (the number of users satisfying t<ti≦t+1/the number of users satisfying ti≧t). For example, the hazard function in the example shown in FIGS. 1 to 3 is H(1)=0/5=0, H(2)=0/5=0, H(3)=1/5, H(4)=2/4=1/2, and H(5)=2/2=1.

Further, FIG. 5 illustrates the hazard function H(t) which is calculated by using the above method for N number of users who have started a certain service in the same month, where the base unit time t is one month and the period T of interest is 26 months. In FIG. 5, the horizontal axis indicates the survival time, and the vertical axis indicates the hazard.

### (Objectives)

The statistics which are obtained by the survival time analysis as described above are calculated for a group made up of a plurality of elements (e.g. a group of persons), and they are calculated emphasizing on the time when an incident of interest occurred as is obvious from the definitional equations. This is because the survival time analysis has been originally used mainly in the medical and pharmaceutical fields, and in those fields, the state in which no incident occurs continues until the incident of interest occurs in many cases.

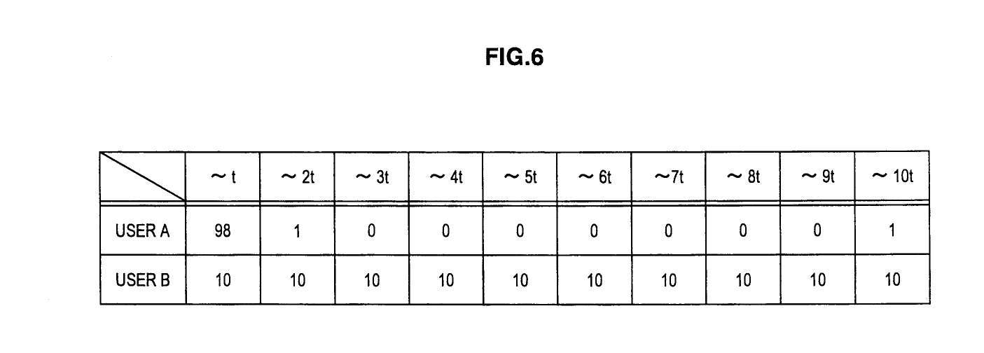

On the other hand, in relation to focusing attention on the incident that “the user withdraws from the service” which is taken as an example in the above description, the case where the survival time analysis is performed by using a state (event) of “user's login to the service” which occurs in a discrete manner is considered. When analyzing the time to the occurrence of a certain incident by using data (event occurrence time information etc.) that represents the pattern of occurrences of the state which occurs in a discrete manner, it is assumed that two users having the same incident occurrence time (survival time) exist as illustrated in FIG. 6. When the calculation period of 1≦t≦10 is of interest, the user A and the user B respectively perform specific processing (e.g. login to the service) 100 times in total. However, while the user A performs the specific processing 98 times in the leftmost interval (the interval to t), the user B performs the specific processing in an average manner in the respective intervals, so that the behaviors of the user A and the user B are largely different from each other. Because the user A and the user B perform the specific processing in the right most interval (the interval to 10 t), the calculated survival time is the same value between the user A and the user B in spite of that there is a large difference in the users' behaviors.

As described above, the survival time analysis according to related art has a problem that, even if the behaviors up to the final occurrence of the incident are different, when the final occurrence time of the incident is the same, the calculated statistics such as the survival time are the same.

Further, in the marketing field, as a method of analyzing the trend of clients, a technique called RFM analysis exists. The RFM analysis is a method that analyzes the trend of a specific individual in terms of the most recent product purchase date (R), the cumulative number of times of purchase (F) and the total purchase amount (M). However, such an analysis technique is the analysis method for the trend of an individual, and it is not applicable to the analysis of a group made up of a plurality of elements, which is the target of the survival time analysis. Further, in the case of analyzing the behaviors of the user A and the user B as illustrated in FIG. 6 by the RFM analysis (in more detail, RF analysis), the interval of the last login is the same (R is the same) and the cumulative number of times of login is also the same (F is the same) between the user A and the user B. Therefore, in the RFM analysis, the evaluations for the user A and the user B are the same, and they are indistinguishable in spite that the behaviors of those users are different.

In view of the foregoing, according to an embodiment of the present invention described hereinbelow, it is an objective to provide an information processing device and an information processing method which can calculate statistics for a group of a plurality of elements in consideration of the pattern of occurrences of an event that is used for determining the occurrence of an incident. The inventor of the present invention has conducted intensive studies in order to achieve the objective and has found an information processing device and an information processing method as described below. The information processing device and the information processing method are described hereinafter in detail.

### First Embodiment

### Configuration of Information Processing Device

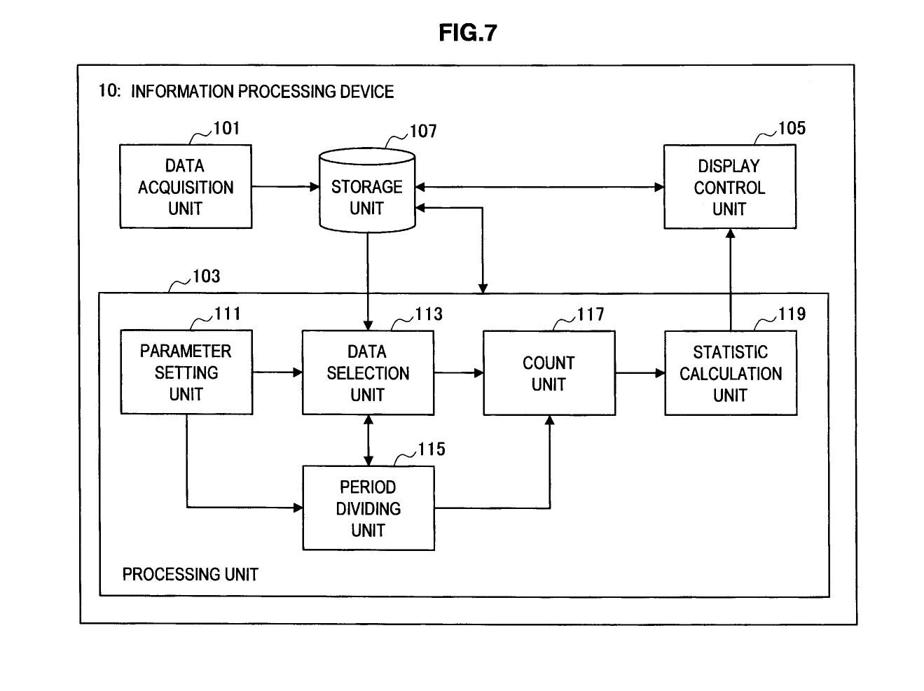

Based on the basic technology described above, a configuration of an information processing device according to a first embodiment of the present invention is described in detail firstly with reference to FIG. 7. FIG. 7 is a block diagram to explain the configuration of the information processing device according to the embodiment.

The information processing device 10 according to the embodiment mainly includes a data acquisition unit 101, a processing unit 103, a display control unit 105, and a storage unit 107 as shown in FIG. 7, for example.

The data acquisition unit 101 is implemented by CPU (Central Processing Unit), ROM (Read Only Memory), RAM (Random Access Memory), a communication device or the like, for example. The data acquisition unit 101 acquires various kinds of data such as event occurrence time information to be used for calculation of statistics from various devices.

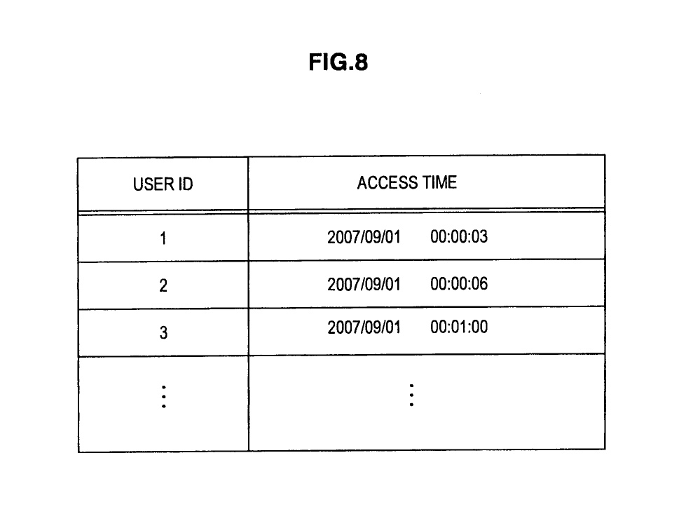

In the event occurrence time information, the time when an event which is used for determining the occurrence of an incident in a group made up of a plurality of elements (e.g. a group of users) occurs is described. With the event occurrence time information, information (e.g. identification information such as a user ID) for specifying the element of the group which is relevant to the occurrence of the event may be associated. FIG. 8 shows an example of the event occurrence time information. In FIG. 8, login processing performed by a user is of interest as the event, and identification information (user ID) of the user who performed the login processing is recorded in association with time information at which the login processing was performed. Note that the event occurrence time information as typified by the history information shown in FIG. 8 is just an example, and arbitrary data may be used as long as the event occurrence time and the information for identifying the element relevant to the occurrence of the event are associated with each other.

The data acquisition unit 101 stores the acquired event occurrence time information into the storage unit 107, which is described later, or the like. Further, the data acquisition unit 101 may transmit the acquired event occurrence time information directly to the processing unit 103, which is described later.

The processing unit 103 is implemented by CPU, ROM, RAM or the like, for example. The processing unit 103 is a processing unit that performs an operation for calculating various kinds of statistics in a group made up of a plurality of elements. The processing unit 103 is descried in detail later.

The display control unit 105 is implemented by CPU, ROM, RAM or the like, for example. The display control unit 105 performs display control for displaying the various kinds of statistics in the group made up of the plurality of elements which are calculated by the processing unit 103 on a display unit (not shown) included in the information processing device 10 according to the embodiment.

The storage unit 107 is an example of a storage device which is included in the information processing device 10 according to the embodiment. In the storage unit 107, the event occurrence time information or the like which is acquired by the data acquisition unit 101 from various device is stored, for example. Further, in the storage unit 107, various parameters, the progress of processing or the like which is necessary to be stored when the information processing device 10 performs some kind of processing, various kinds of database and so on are stored as appropriate. Each processing unit included in the information processing device 10 according to the embodiment can freely read and write data to and from the storage unit 107.

### [Configuration of Processing Unit]

The processing unit 103 which is included in the information processing device 10 according to the embodiment is described hereinafter in detail.

The processing unit 103 according to the embodiment mainly includes a parameter setting unit 111, a data selection unit 113, a period dividing unit 115, a count unit 117, and a statistic calculation unit 119 as shown in FIG. 1, for example.

The parameter setting unit 111 is implemented by CPU, ROM, RAM or the like, for example. The parameter setting unit 111 sets parameters to be used for calculation of various kinds of statistics which is performed in the processing unit 103 according to the embodiment. Examples of such parameters are a starting point S of a period of interest when calculating statistics, the length of the period (calculation period) T, and the length of a unit period (base unit time) t. In addition to those parameters, the parameter setting unit 111 may further set various kinds of parameters which are necessary for calculation of statistics as appropriate.

Note that those parameters may have values which are automatically set by the parameter setting unit 111, or values which are input by a user through an input unit (not shown) such as a keyboard or a touch panel that is mounted on the information processing device 10.

After setting parameters, the parameter setting unit 111 outputs the set parameters to the data selection unit 113 and the period dividing unit 115, which are described later. Further, the parameter setting unit 111 may store the set parameters into the count unit 117.

The data selection unit 113 is implemented by CPU, ROM, RAM or the like, for example. The data selection unit 113 selects event occurrence time information for which statistics are to be calculated from the plurality of event occurrence time information stored in the storage unit 107 based on the parameters notified from the parameter setting unit 111. Specifically, the data selection unit 113 selects the event occurrence time information in which the event occurs during the first unit period S to S+t of the calculation period T by using the starting point S of the period of interest and the base unit time t which are notified from the parameter setting unit 111. Then, the data selection unit 113 specifies the element (e.g. user) which corresponds to the event occurrence time information in which the event occurs during the unit period S to S+t and selects the event occurrence time information associated with the specified element from the event occurrence time information stored in the storage unit 107. The data selection unit 113 can thereby select the event occurrence time information in which the event occurs during S to S+t with respect to each element (e.g. each user). A group of the event occurrence time information with respect to each element selected in this manner is a population when calculating statistics. Further, the data selection unit 113 can specify the total number of elements included in the population by focusing attention on the number of selected elements.

The data selection unit 113 acquires the selected event occurrence time information from the storage unit 107 and transmits the information to the count unit 117, which is descried later.

The period dividing unit 115 is implemented by CPU, ROM, RAM or the like, for example. The period dividing unit 115 divides the calculation period T for which statistics are to be calculated into a plurality of unit periods by using the base unit time t based on the parameters notified from the parameter setting unit 111. Specifically, the period dividing unit 115 adds the base unit time t to the parameter S indicating the starting point of the period of interest, sets the time represented by the obtained (S+t) as a first break, and sets the period of S to S+t as a first unit period. Likewise, the period dividing unit 115 adds the base unit time t to (S+t), sets the time represented by the obtained (S+2t) as a second break, and sets the period of S+t to S+2t as a second unit period. By repeating such processing until the calculation period becomes T (repeating the processing T/t times), the period dividing unit 115 can divide the calculation period T on the base unit time t basis. By referring to the time at the breakpoint, the count unit 117 and the statistic calculation unit 119, which are described later, can figure out in which unit interval the occurrence time of a certain event is included.

The period dividing unit 115 outputs the calculated time at the breakpoint to the count unit 117, which is described later. Further, the period dividing unit 115 may store the calculated time at the breakpoint into the storage unit 107 or the like.

The count unit 117 is implemented by CPU, ROM, RAM or the like, for example. The count unit 117 counts the number of occurrences of the event for each unit period based on the event occurrence time information notified from the data selection unit 113 and the information related to the time at the breakpoint notified from the period dividing unit 115. The count unit 117 can thereby specify how many times the event occurred during which unit period for each of the elements (e.g. each user).

The count unit 117 may count the number of event occurrences in each unit period in a specific manner such as 5 times, 10 times and so on. Further, the count unit 17 may count 1 when the event occurs during the unit period regardless of the specific number of occurrences of the event and count 0 when the event does not occur. In other words, the count unit 117 may binarize the number of occurrences of the event depending on the presence or absence of the occurrence of the event.

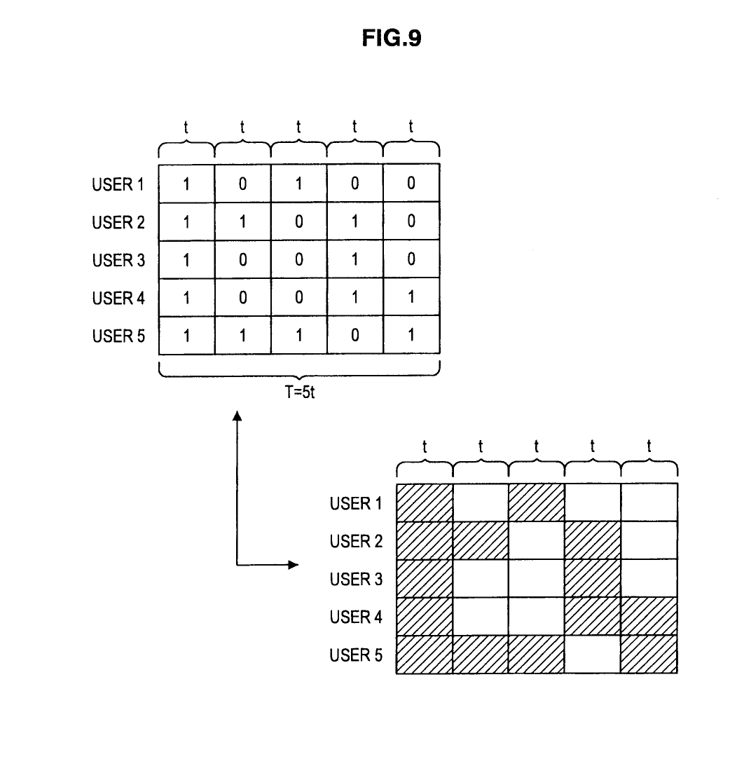

By the above processing, the count unit 117 can generate data as shown in the upper part of FIG. 9. Note that FIG. 9 illustrates the case where the number of occurrences of the event is binarized. Further, by binarizing the number of occurrences of the event, the time series related to the event occurrences can be patterned. As a result, the correspondence as to which element causes the occurrence of the event during which unit interval can be treated as sort of a binary image as shown in the lower part of FIG. 9. Note that, in the lower part of FIG. 9, the unit interval indicated by diagonal shading corresponds to the unit interval during which the event occurred.

The count unit 117 notifies information indicating the count result based on the event occurrence time information to the statistic calculation unit 119, which is described later. Further, the count unit 117 may store the generated information indicating the count result into the storage unit 107 or the like.

The statistic calculation unit 119 is implemented by CPU, ROM, RAM or the like, for example. The statistic calculation unit 119 calculates a statistic which indicates the pattern of occurrences of the given event by using the information indicating the count result notified from the count unit 117. More specifically, the statistic calculation unit 119 calculates a weighted average survival time, which is described later, as the statistic in consideration of the pattern of event occurrences (the time series indicating the pattern of event occurrences) by using the information indicating the count result notified from the count unit 117.

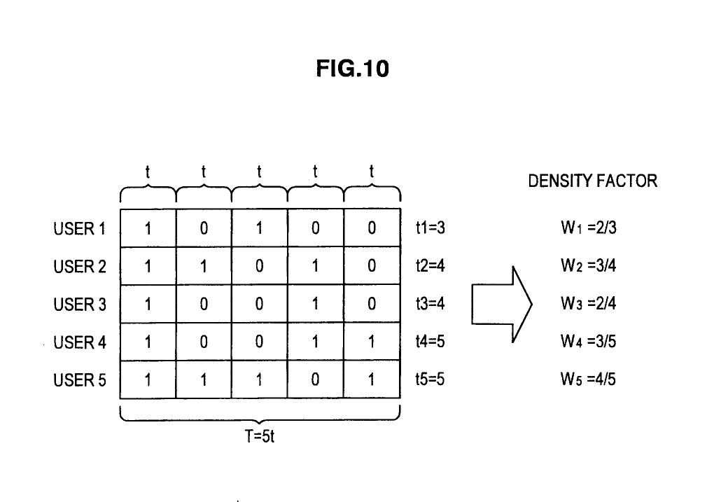

A procedure to calculate the weighted average survival time in the statistic calculation unit 119 is described hereinafter with reference to FIG. 10.

First, the statistic calculation unit 119 specifies the unit period during which the incident of interest occurred (e.g. the unit period during which a user made access last time within the calculation period T) by referring to the information indicating the count result notified from the count unit 117. In other words, the unit period during which the incident of interest occurred corresponds to the survival time. In the example shown in FIG. 10, the unit period ti during which the incident of interest occurred in relation to the user i is t1=3, t2=4, t3=4, t4=5 and t5=5.

Next, the statistic calculation unit 119 counts the number of occurrences of the event from the starting point of the period of interest to ti for each user. In the example shown in FIG. 10, the number of occurrences for the user 1 is two times, for the user 2 is three times, for the user 3 is two times, for the user 4 is three times, and for the user 5 is four times.

Then, the statistic calculation unit 119 calculates a density factor Wᵢ which indicates the density of occurrences of the event by using the number of occurrences of the event from the starting point to ti and the unit period (i.e. the survival time) during which the incident of interest occurred. Specifically, the statistic calculation unit 119 calculates the density factor Wᵢ by the following expression 101.

Density factor Wᵢ=(the number of occurrences of the event within the survival time)/(the survival time) (Expression 101)

Therefore, in the example shown in FIG. 10, the density factor W₁ of the user 1 is ⅔, the density factor W₂ of the user 2 is ¾, the density factor W₃ of the user 3 is 2/4, the density factor W₄ of the user 4 is ⅗, and the density factor W₅ of the user 5 is ⅘.

After that, the statistic calculation unit 119 calculates a weighted average survival time A by the following expression 102 by using the calculated density factor Wᵢ and the unit period (i.e. the survival time) ti during which the incident of interest occurred. In the following expression 102, N is the total number of elements included in the population of interest.

$$A = \frac{1}{N} {\sum }_{i = 1}^{N} {t}_{i} \times {W}_{i} \qquad ( Expression 102 )$$

The density factor Wᵢ which is used for calculation of the weighted average survival time is a factor in consideration of the pattern of occurrences of the event (the time series indicating the pattern of occurrences of the event) as is obvious from the definitional equation shown in the expression 101. Therefore, the weighted average survival time calculated based on the expression 102 is the statistics in consideration of the time series indicating the pattern of occurrences of the event (specifically, the average number of occurrences of the event in consideration of the pattern of occurrences of the event).

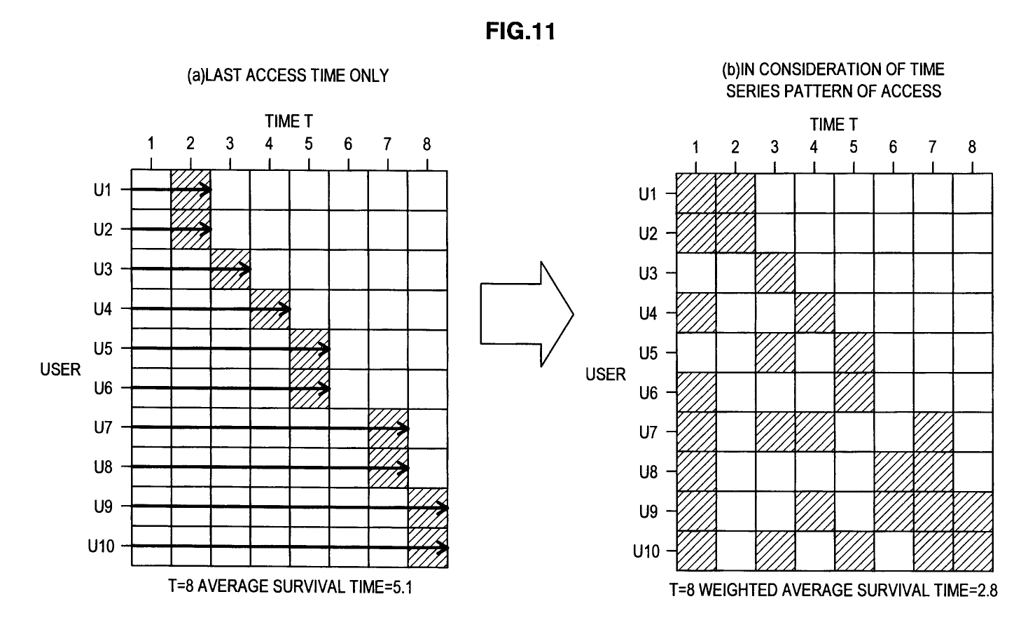

The average survival time which is calculated by the survival time analysis according to related art is the statistic which is calculated emphasizing on the time when the incident of interest occurred as shown in FIG. 11A. Therefore, when the incident of interest occurred during the unit period indicated by diagonal shading in FIG. 11A, the average survival time is calculated as 5.1 in consideration of only the position of the unit period.

On the other hand, the count result indicating the access pattern shown in FIG. 11B has the same incident occurrence times as those of the count result shown in FIG. 11A. When the pattern of occurrences of the event until the incident of interest occurs is represented by the time series pattern as shown in FIG. 11B, the weighted average survival time which is calculated based on the expression 102 is 2.8.

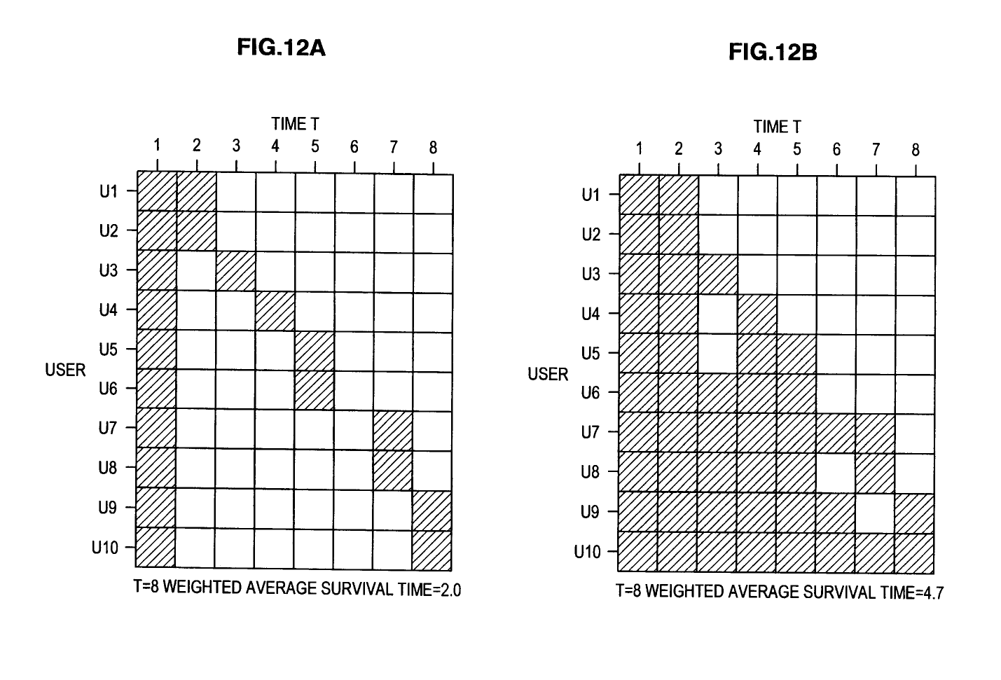

Further, although FIGS. 12A and 12B show the case of having the same survival times as those of the count result indicating the access pattern shown in FIG. 11B, the pattern of occurrences of the event is different among the three. Therefore, the weighted average survival time which is calculated in the case of the pattern of event occurrences shown in FIG. 12A is 2.0, and the weighted average survival time which is calculated in the case of the pattern of event occurrences shown in FIG. 12B is 4.7, which are different values from that of FIG. 11B.

As is obvious from the examples shown in FIGS. 11 to 12B, by using the weighted average survival time A which is calculated by the statistic calculation unit 119 according to the embodiment, it is possible to analyze the population having the same survival time in further detail and differentiate among them.

Note that, as is obvious from the comparison between the expression 102 and the expression 18, the average survival time which is calculated by the survival time analysis according to related art corresponds to the case where the weighting factor Wᵢ is set to 1 in the weighted average survival time which is calculated by the statistic calculation unit 119 according to the embodiment. Therefore, the statistic calculation unit 119 according to the embodiment can also calculate the average survival time according to related art by setting the weighting factor in the expression 102.

Note that the statistic calculation unit 119 specifies the survival time ti for each element in the process of calculating weighted average survival time. Therefore, the statistic calculation unit 119 can calculate the survival function S(t) (specifically, the Kaplan-Meier estimate) by using the survival time ti and the total number of elements N. Further, the statistic calculation unit 119 can also calculate the half-life and the hazard function by using the calculated survival function S(t).

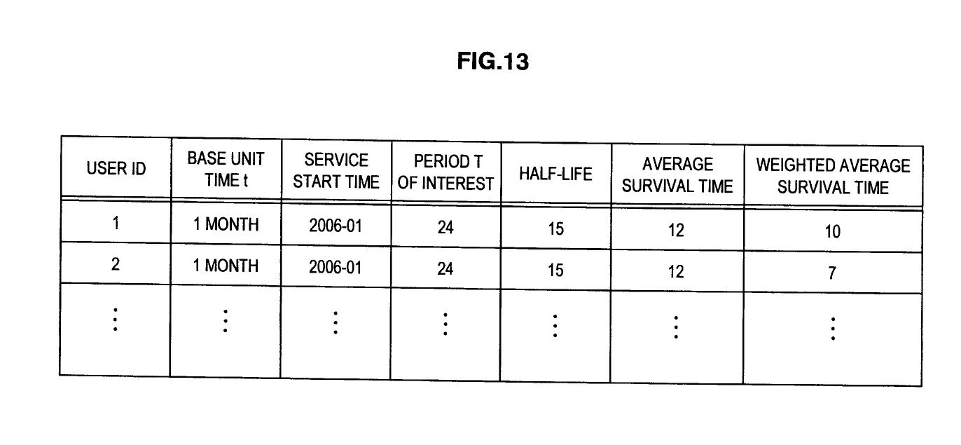

The statistic calculation unit 119 outputs various statistics including the weighted average survival time calculated in the above manner to the display control unit 105 and displays the calculated statistics on a display unit (not shown) or the like included in the information processing device 10 through the display control unit 105. The statistic calculation unit 119 may output the calculated various statistics in the form of database as shown in FIG. 13.

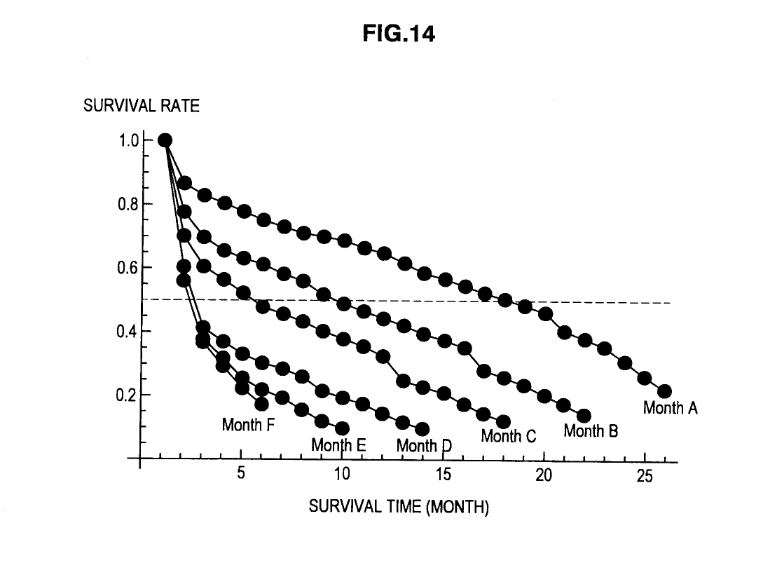

FIG. 14 illustrates a plurality of survival functions, where the calculation period T is one month, which are calculated by the statistic calculation unit 119. A user of the information processing device 10 can make quantitative evaluation of the behaviors of elements in a group of plurality of elements by comparing such survival functions, hazard functions, weighted average survival times, half-lives and so on with one another.

Evaluating user's survival time and statistics associated with the survival time is important in terms of user (i.e. client) value evaluation or user management. Particularly, in the case of applying the statistics including the weighted average survival time to client evaluation or the like based on access history information, it is possible to make objective differentiation between a group of clients who make access on a regular basis and a group of clients who do not make such access. Accordingly, a user of the information processing device 10 can objectively make various kinds of evaluation such as detailed classification of clients and evaluation of advertising effectiveness. Further, by using the density factor which is used for calculation of the weighted average survival time, a user of the information processing device 10 can regard a client with a high density factor in spite of a small cumulative number of accesses as a potential prime client.

It should be noted that the statistic calculation unit 119 may output various statistics calculated in the above manner as data to various devices placed externally to the information processing device 10. Further, the statistic calculation unit 119 may store those calculated statistics into the storage unit 107.

An example of the functions of the information processing device 10 according to the embodiment is described above. Each of the above-described elements may be configured using a general-purpose member or circuit, or it may be configured by hardware specialized to the function of each element. Further, the function of each element may be entirely realized by CPU or the like. It is thereby possible to change the configuration to use as appropriate according to the technique level when implementing the embodiment.

It is feasible to create a computer program for achieving the respective functions of the information processing device according to the embodiment as described above and implement the computer program in a personal computer or the like. Further, it is feasible to provide a computer-readable recording medium that stores such a computer program. The recording medium may be a magnetic disk, an optical disk, a magneto-optical disk, a flash memory or the like, for example. Further, the above-described computer program may be distributed through a network, for example, without using the recording medium.

### <Information Processing Method>

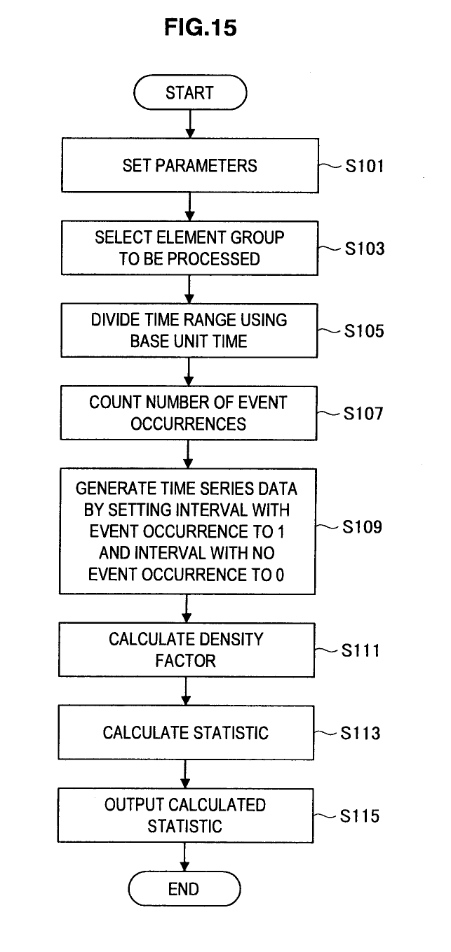

An information processing method (specifically, a statistic calculation method) which is implemented in the information processing device 10 according to the embodiment is briefly described hereinafter with reference to FIG. 15. FIG. 15 is an explanatory view to explain the information processing method according to the embodiment.

Note that, before providing the following description, it is assumed that the data acquisition unit 101 of the information processing device 10 has acquired the event occurrence time information to be used for calculation of statistics from a given device or a given part and stored the information into the storage unit 107.

First, the parameter setting unit 111 of the processing unit 103 sets the starting point S of the period for which calculation is made, the length T of the period, and the length of the base unit time t as parameters for calculation (step S101). The parameter setting unit 111 notifies the set parameters to the data selection unit 113 and the period dividing unit 115.

Next, the data selection unit 113 selects the event occurrence time information in which a given event occurs during the period S to S+t based on the parameters notified from the parameter setting unit 111. The data selection unit 113 then specifies the element associated with the selected event occurrence time information and selects the event occurrence time information associated with the specified element from the event occurrence time information stored in the storage unit 107. The event occurrence time information selected in this manner constitutes a group of elements when calculating statistics (step S103). The data selection unit 113 transmits the selected event occurrence time information to the count unit 117.

Further, the period dividing unit 115 divides the calculation period T into a plurality of unit periods by using the base unit time t based on the parameters notified from the parameter setting unit 111 (step S105). The time at the breakpoint of the respective unit periods is thereby specified. The period dividing unit 115 notifies information related to the specified time at the breakpoint to the count unit 117.

Then, the count unit 117 counts the number of occurrences of the event for each unit period based on the event occurrence time information transmitted from the data selection unit 113 and the information related to the time at the breakpoint notified from the period dividing unit 115 (step S107). At this time, the count unit 117 generates times series data of the event occurrences by setting the number of event occurrences in the interval in which the event occurs to 1 and setting the number of event occurrences in the interval in which the event does not occur to 0 (step S109). The count unit 117 notifies the time series data of the event occurrences generated in this manner to the statistic calculation unit 119.

The statistic calculation unit 119 first calculates the above-described density factor Wᵢ for each element by using the time series data of the event occurrences notified from the count unit 117 (step S111). The statistic calculation unit 119 then calculates the weighted average survival time according to the embodiment by using the density factor Wᵢ and the survival time ti of each element (step S113). In addition to the weighted average survival time, the statistic calculation unit 119 may further calculate statistics such as a survival function, a hazard function, a half-life and an average survival time (step S113).

The statistic calculation unit 119 then outputs the calculated statistics to the display control unit 105 or various devices with which the information processing device 10 can communicate (step S115).

By performing the above process, the information processing method according to the embodiment can calculate statistics in consideration of the pattern of event occurrences.

### (Hardware Configuration)

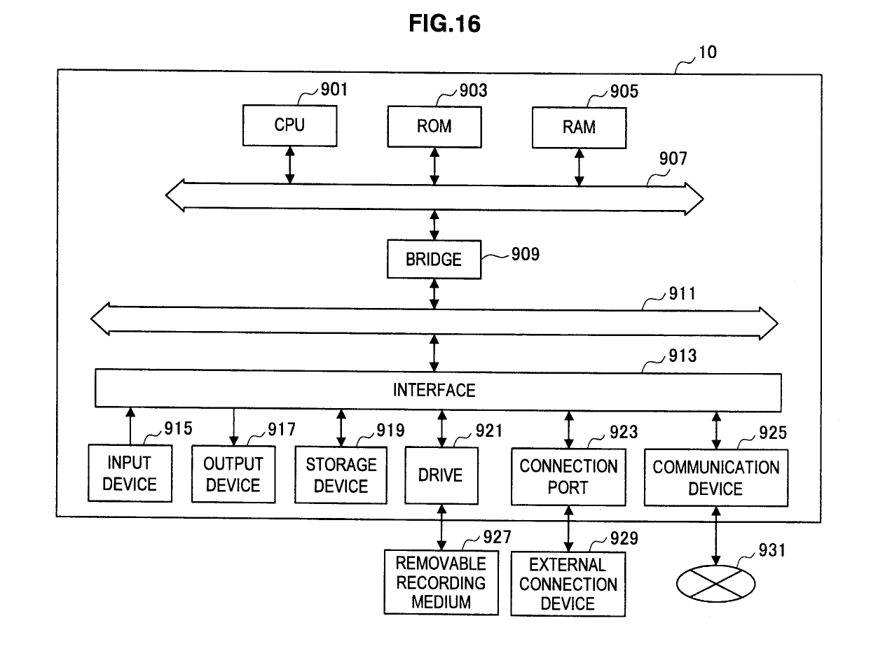

Next, the hardware configuration of the information processing apparatus 10 according to the embodiment of the present invention will be described in detail with reference to FIG. 16. FIG. 16 is a block diagram for illustrating the hardware configuration of the information processing apparatus 10 according to the embodiment of the present invention.

The information processing apparatus 10 mainly includes a CPU 901, a ROM 903, and a RAM 905. Furthermore, the information processing apparatus 10 also includes a host bus 907, a bridge 909, an external bus 911, an interface 913, an input device 915, an output device 917, a storage device 919, a drive 921, a connection port 923, and a communication device 925.

The CPU 901 serves as an arithmetic processing apparatus and a control device, and controls the overall operation or a part of the operation of the information processing apparatus 10 according to various programs recorded in the ROM 903, the RAM 905, the storage device 919, or a removable recording medium 927. The ROM 903 stores programs, operation parameters, and the like used by the CPU 901.

The RAM 905 primarily stores programs used in execution of the CPU 901 and parameters and the like varying as appropriate during the execution. These are connected with each other via the host bus 907 configured from an internal bus such as a CPU bus or the like.

The host bus 907 is connected to the external bus 911 such as a PCI (Peripheral Component Interconnect/Interface) bus via the bridge 909.

The input device 915 is an operation means operated by a user, such as a mouse, a keyboard, a touch panel, buttons, a switch and a lever. Also, the input device 915 may be a remote control means (a so-called remote control) using, for example, infrared light or other radio waves, or may be an externally connected device 929 such as a mobile phone or a PDA conforming to the operation of the information processing apparatus 10. Furthermore, the input device 915 generates an input signal based on, for example, information which is input by a user with the above operation means, and is configured from an input control circuit for outputting the input signal to the CPU 901. The user of the information processing apparatus 10 can input various data to the information processing apparatus 10 and can instruct the information processing apparatus 10 to perform processing by operating this input apparatus 915.

The output device 917 is configured from a device capable of visually or audibly notifying acquired information to a user. Examples of such device include display devices such as a CRT display device, a liquid crystal display device, a plasma display device, an EL display device and lamps, audio output devices such as a speaker and a headphone, a printer, a mobile phone, a facsimile machine, and the like. For example, the output device 917 outputs a result obtained by various processings performed by the information processing apparatus 10. More specifically, the display device displays, in the form of texts or images, a result obtained by various processes performed by the information processing apparatus 10. On the other hand, the audio output device converts an audio signal such as reproduced audio data and sound data into an analog signal, and outputs the analog signal.

The storage device 919 is a device for storing data configured as an example of a storage unit of the information processing apparatus 10 and is used to store data. The storage device 919 is configured from, for example, a magnetic storage device such as a HDD (Hard Disk Drive), a semiconductor storage device, an optical storage device, or a magneto-optical storage device. This storage device 919 stores programs to be executed by the CPU 901, various data, and various data obtained from the outside.

The drive 921 is a reader/writer for recording medium, and is embedded in the information processing apparatus 10 or attached externally thereto. The drive 921 reads information recorded in the attached removable recording medium 927 such as a magnetic disk, an optical disk, a magneto-optical disk, or a semiconductor memory, and outputs the read information to the RAM 905. Furthermore, the drive 921 can write in the attached removable recording medium 927 such as a magnetic disk, an optical disk, a magneto-optical disk, or a semiconductor memory. The removable recording medium 927 is, for example, a DVD medium, an HD-DVD medium, or a Blu-ray medium. The removable recording medium 927 may be a CompactFlash (CF; registered trademark), a flash memory, an SD memory card (Secure Digital Memory Card), or the like. Alternatively, the removable recording medium 927 may be, for example, an IC card (Integrated Circuit Card) equipped with a non-contact IC chip or an electronic appliance.

The connection port 923 is a port for allowing devices to directly connect to the information processing apparatus 10. Examples of the connection port 923 include a USB (Universal Serial Bus) port, an IEEE1394 port, a SCSI (Small Computer System Interface) port, and the like. Other examples of the connection port 923 include an RS-232C port, an optical audio terminal, an HDMI (High-Definition Multimedia Interface) port, and the like. By the externally connected apparatus 929 connecting to this connection port 923, the information processing apparatus 10 directly obtains various data from the externally connected apparatus 929 and provides various data to the externally connected apparatus 929.

The communication device 925 is a communication interface configured from, for example, a communication device for connecting to a communication network 931. The communication device 925 is, for example, a wired or wireless LAN (Local Area Network), Bluetooth (registered trademark), a communication card for WUSB (Wireless USB), or the like. Alternatively, the communication device 925 may be a router for optical communication, a router for ADSL (Asymmetric Digital Subscriber Line), a modem for various communications, or the like. This communication device 925 can transmit and receive signals and the like in accordance with a predetermined protocol such as TCP/IP on the Internet and with other communication devices, for example. The communication network 931 connected to the communication device 925 is configured from a network and the like, which is connected via wire or wirelessly, and may be, for example, the Internet, a home LAN, infrared communication, radio wave communication, satellite communication,

Heretofore, an example of the hardware configuration capable of realizing the functions of the information processing apparatus 10 according to the embodiment of the present invention has been shown. Each of the structural elements described above may be configured using a general-purpose material, or may be configured from hardware dedicated to the function of each structural element. Accordingly, the hardware configuration to be used can be changed as appropriate according to the technical level at the time of carrying out the present embodiment.

### (Summary)

As described above, the information processing device and the information processing method according to the embodiment of the present invention calculate the density factor related to the event occurrences in consideration of the pattern of event occurrences and calculates the weighted average survival time in consideration of the pattern of event occurrences by using the density factor. By using the weighted average survival time, a user of the information processing device can make detailed classification of elements even when there are a plurality of elements having the same survival time.

Although preferred embodiments of the present invention are described in detail above with reference to the appended drawings, the present invention is not limited thereto. It should be understood by those skilled in the art that various modifications, combinations, sub-combinations and alterations may occur depending on design requirements and other factors insofar as they are within the scope of the appended claims or the equivalents thereof.

For example, although the statistic calculation method according to the present invention is described taking classification of users using login history information of the users as an example, the present invention is not limited thereto. The statistic calculation method according to the present invention may be applied to arbitrary information as long as the occurrence of a certain event and the occurrence time are associated with each other.

The present application contains subject matter related to that disclosed in Japanese Priority Patent Application JP 2009-296061 filed in the Japan Patent Office on Dec. 25, 2009, the entire content of which is hereby incorporated by reference.

What is claimed is:

1. An information processing device comprising:
a parameter setting unit that sets a parameter to be used for calculating a given statistic based on event occurrence time information related to a time when a certain event occurred;
a period dividing unit that divides a calculation period for which the given statistic is calculated into a plurality of unit periods based on a base unit time set by the parameter setting unit;
a count unit that counts a number of occurrences of the certain event for each of the plurality of unit periods based on the event occurrence time information; and
a statistic calculation unit that calculates a statistic indicating a pattern of occurrences of the certain event by using a count result of the count unit.

2. The information processing device according to claim 1, wherein
the count unit specifies a most recent unit period during which the certain event occurred from the calculation period, and
the statistic calculation unit calculates a density of occurrences of the certain event by using a number of occurrences of the certain event up to the most recent unit period, and calculates an average number of occurrences of the certain event within the calculation period by using the density of occurrences of the certain event and a number of the unit periods included up to the most recent unit period.

3. The information processing device according to claim 2, further comprising:
a selection unit that selects the event occurrence time information with the same calculation period from a plurality of event occurrence time information,
wherein the count unit counts the number of occurrences of the certain event based on the event occurrence time information selected by the selection unit.

4. The information processing device according to claim 3, wherein
the statistic calculation unit calculates an average number A of occurrences of the certain event based on an expression 1, where a number of the event occurrence time information selected by the selection unit is N, the density of occurrences of the event is Wᵢ, and the number of the unit periods included up to the most recent unit period is tᵢ.
$$A = \frac{1}{N} {\sum }_{i = 1}^{N} {t}_{i} \times {W}_{i} \qquad ( Expression 1 )$$

5. The information processing device according to claim 1, wherein
when the certain event occurs during the unit period, the count unit counts the number of occurrences of the certain event in the unit period as 1 regardless of the number of occurrences.

6. The information processing device according to claim 1, wherein
the statistic calculation unit further calculates a survival function indicating a rate of occurrence of the event, a hazard function of the event, and an event occurrence half-life indicating a period until the number of occurrences of the event becomes half based on the count result of the count unit.

7. An information processing method comprising the steps of:
setting a parameter to be used for calculating a given statistic based on event occurrence time information related to a time when a certain event occurred;
dividing a calculation period for which the given statistic is calculated into a plurality of unit periods based on a base unit time set in the parameter setting step;
counting a number of occurrences of the certain event for each of the plurality of unit periods based on the event occurrence time information; and
calculating a statistic indicating a pattern of occurrences of the certain event by using a count result in the counting step.

8. A program causing a computer to implement functions comprising:
a parameter setting function that sets a parameter to be used for calculating a given statistic based on event occurrence time information related to a time when a certain event occurred;
a period dividing function that divides a calculation period for which the given statistic is calculated into a plurality of unit periods based on a base unit time set by the parameter setting function;
a count function that counts a number of occurrences of the certain event for each of the plurality of unit periods based on the event occurrence time information; and
a statistic calculation function that calculates a statistic indicating a pattern of occurrences of the certain event by using a count result of the count function.
